(19) United States
(12) Patent Application Publication
(10) Pub. No.: US 2026/0290783 A1
(43) Pub. Date: Sep. 24, 2026

(54) Method for Producing at Least One Electrode, in Particular for a Storage Cell for Storing Electrical Energy

(71) Applicant: Bayerische Motoren Werke Aktiengesellschaft, Muenchen (DE)

(72) Inventor: Victor SCHOB, Stephanskirchen (DE)

(21) Appl. No.: 19/490,034

(22) PCT Filed: May 28, 2024
(86) PCT No.: PCT/DE2024/100486

§ 371 Date: Dec. 4, 2025

(30) Foreign Application Priority Data
Jun. 5, 2023 (DE) 10 2023 114 687.4

(51) Int. Cl. H01M 4/04

(52) U.S. Cl. CPC H01M 4/0435; H01M 4/0404; H01M 4/0471

(57) ABSTRACT

A method for producing at least one electrode is described. At least two coating tracks made of an active material are applied, mutually adjacently, to a conductor foil such that the coating tracks are mutually spaced, whereby a strip of the conductor foil not coated with the active material runs between the coating tracks. The conductor foil provided with the coating tracks is fed to a dryer line and is conveyed through the dryer line, whereby the coating tracks are dried. After drying, the conductor foil provided with the coating tracks is fed to a first deflecting roller adjoining an end of the dryer line, whereby the conductor foil provided with the coating tracks is deflected, and an electrode is produced.

### BACKGROUND AND SUMMARY

The invention relates to a method for producing at least one electrode, according to the preamble of the independent claim, in particular for a storage cell for storing, in particular electrochemically, electrical energy.

An electrode arrangement for a battery cell is known from DE 10 2018 200 553 A1. Furthermore, DE 10 2015 104 439 B4 discloses an electrochromic element. In addition, JP 6156398 B2 discloses a method for producing an electrode.

The object of the present disclosure is to provide a method by way of which an electrode, in particular for a storage cell for storing, in particular electrochemically, electrical energy can be produced particularly advantageously.

This object is achieved according to the disclosure by a method having the features of the independent claim. Advantageous designs of the disclosure are the subject matter of the dependent claims.

In the method according to the disclosure for producing at least one electrode, in particular for a storage cell for storing, in particular electrochemically, electrical energy, at least two coating tracks made of active material are applied adjacent to one another to an, in particular metallic, conductor foil, which is also simply referred to as a foil, such that the coating tracks are spaced apart from one another, in particular along a spacing straight line also referred to as a first straight line, so that an uncoated strip, therefore not coated using the active material, of the conductor foil extends in particular along the first straight line between the coating tracks, which strip is therefore free of the active material and in particular free of any coating. This means that the active material is in particular applied in the liquid state of the active material to the conductor foil, i.e. to a first surface of the conductor foil, such that the coating tracks, which are also referred to as coating strips, are formed, i.e. produced, from the active material. The first surface is arranged here on a first side of the conductor foil and is formed by a first side of the conductor foil, wherein the first side is also referred to as the upper side of the conductor foil. Therefore, the strip not coated using the active material is also formed by the surface, therefore a part of the surface not coated using the active material, so that the strip is arranged on the upper side or formed by the upper side. In still other words, the strip and the coating tracks are arranged on the same side, in particular upper side, of the active foil. In particular, for example, the coating tracks made of the active material are applied to the conductor foil, while the conductor foil is conveyed along a conveying direction and therefore moved, in particular such that the conductor foil is moved, in particular translationally, in particular along the conveying direction, relative to an applicator unit also referred to as an application unit, by way of which the coating tracks are applied to the conductor foil, therefore to the first surface and in particular on the upper side here. In that the coating tracks made of the active material are applied to the conductor foil, the conductor foil is provided with the coating tracks, wherein in particular the coating tracks adhere to the conductor foil. A structural unit, which comprises the conductor foil provided with the coating tracks, therefore the coating tracks and the conductor foil, is formed from the conductor foil and the coating tracks by the application of the coating tracks to the conductor foil.

In the method, the conductor foil provided with the coating tracks, therefore the structural unit, is supplied to a dryer line and conveyed through the dryer line, in particular such that the structural unit moves toward the dryer line, is moved into the dryer line, and is moved through the dryer line along the conveying direction, wherein the coating tracks, i.e. the active material forming the coating tracks, is dried by way of the dryer line. The drying of the active material or the coating tracks is to be understood to mean that a moisture content of the respective coating track, i.e. an amount of liquid, in particular water, absorbed in the active material forming the respective coating track, is reduced. For this purpose, for example, the coating tracks are heated by way of the dryer line, in particular while the structural unit is in particular conveyed along the conveying direction through the dryer line, i.e. moved through it. The feature that the structural unit is conveyed through the dryer line is to be understood in particular to mean that the structural unit is in particular moved along the conveying direction relative to the dryer line, in particular translationally, wherein during this the coating tracks are dried by way of the dryer line.

In the method, the conductor foil provided with the coating tracks dried by way of the dryer line is supplied to the first deflection roller adjoining an end of the dryer line, by way of which the conductor foil provided with the coating tracks dried by way of the dryer line, therefore the structural unit, is deflected, specifically, for example, by at least or precisely 90°. In other words, the dryer line and, for example, also the above-mentioned applicator unit are components of a device for producing the at least one electrode, so that the method is carried out or can be carried out by way of the device. The device also comprises the guided deflection roller, which is the first deflection roller at the end of the dryer line and therefore adjoining the dryer line. This means that in particular viewed along the conveying direction between the mentioned deflection roller and the dryer line or the end of the dryer line, no other further deflection roller, by way of which the conductor foil is deflected, is provided. In particular, the structural unit is supplied to the deflection roller such that the structural unit is conveyed along the conveying direction to the deflection roller and is therefore in particular moved toward it translationally. For example, the deflection roller rolls, in particular directly, on a second surface of the conductor foil, wherein the second surface faces away from the first surface. For example, the second surface is formed by a second side of the conductor foil or arranged on a second side of the conductor foil, wherein the second side faces away from the first side of the conductor foil. The second side is also referred to as the lower side of the conductor foil. For example, the conductor foil provided with the dried coating tracks is deflected by way of the deflection roller by at least or precisely 180°. Since the conductor foil provided with the dried coating tracks is deflected by way of the deflection roller, the conductor foil wraps around the deflection roller, for example.

In the method, the at least one electrode is produced from the conductor foil provided with the coating tracks dried by way of the dryer line, therefore from the structural unit. For example, the conductor foil provided with the dried coating tracks is conveyed out of the dryer line and supplied to the deflection roller and deflected by way of the deflection roller, wherein in particular the deflection roller is arranged outside the dryer line. In particular, the dryer line ends at the mentioned end of the dryer line, to the end of which the deflection roller is adjacent.

To now be able to produce the at least one electrode particularly advantageously, it is provided according to the disclosure that by way of at least one roller provided in addition to the deflection roller after the end of the dryer line and before the deflection roller, i.e. before the conductor foil is deflected by way of the deflection roller and before the conductor foil touches the deflection roller, a force is exerted at least on the strip of the conductor foil in that the roller touches at least the strip and rolls, in particular directly, on the strip. In particular, the mentioned force is exerted on the strip such that the force acts from the first side toward the second side, therefore from the upper side toward the lower side. By way of the roller, i.e. in that the force is exerted on the strip by way of the roller, excessive wrinkling of the conductor foil can be avoided in particular in the area of the strip, so that the at least one electrode can be produced particularly advantageously.

The disclosure is based in particular on the following findings and considerations: The coating strips are applied, for example, by a or during a coating process to the conductor foil, in particular such that the active material is applied in the liquid, for example in the pasty state to the conductor foil, in particular on the first side. For example, the at least one electrode can be used as an electrode for a storage cell designed as a lithium-ion cell for storing, in particular electrochemically, electrical energy, wherein, for example, the storage cell can be used in an or for an electrical energy storage device, in particular of a motor vehicle. It is conceivable here that the electrical energy storage device has multiple such storage cells in its completely produced state, which are electrically interconnected, for example, so that, for example, the electrical energy storage device is a high-voltage component, the electrical voltage of which, in particular electrical operating and rated voltage, is preferably greater than 50 V, in particular greater than 60 V, and is preferably several hundred volts. Typically, the application, also referred to as spreading, of the respective coating track and therefore of the active material takes place on the, preferably metallic, conductor foil in the coating process, which is typically designed as a so-called roll-to-roll process. To produce the at least one electrode or multiple electrodes cost-effectively and to implement a sufficiently high yield in this case, the multiple coating tracks, also referred to as coating strips, are applied adjacent to one another on the conductor foil, such that the above-mentioned non-coated strip is arranged between the coating tracks. In the conventional method, the following problems can now occur: Excessive wrinkling of the strip and therefore of the conductor foil can occur between the coating tracks and therefore at or in the strip. The wrinkling comprises multiple wrinkles of the strip. These wrinkles are irreversible and are introduced into the conductor foil, also referred to as the mother coil, and therefore into the electrode. This can result, in conventional coating processes, in cracking of the conductor foil, also referred to simply as a foil, in the area of the strip, also referred to as a conductor strip, since both longitudinal cracks in the track direction, i.e. along the conveying direction, and also transverse cracks can occur here, for example, which extend obliquely or perpendicularly to the track direction. In particular the transverse cracks can reach areas coated with active material, in which the coating strips are applied to the conductor foil. If the wrinkling is excessively severe, longitudinal areas having such excessively severe wrinkling are assessed as discards and cannot be used to produce electrodes therefrom. In following processes, excessive wrinkling between the coating tracks can result in quality problems. During longitudinal cutting of the conductor foil, by which, for example, the structural unit or the conductor foil is refined to form multiple daughter coils, a cutting tolerance cannot be maintained between the coating tracks, since, for example, due to the excessive wrinkling, the distance between the coating tracks changes impermissibly. It is a technical need here to avoid excessive wrinkling between the coating tracks, also referred to as coating strips. No mechanisms are conventionally provided for this purpose. Typically, attempts are made to minimize this problem by masking the deflection roller in the area of the noncoated strip. However, this only functions to a limited extent since in the event of lateral track movements of the conductor foil or in the event of changing geometry of the conductor foil or the electrode of the strip formed as the uncoated area, in which the wrinkling occurs, its position relative to the deflection roller continuously changes. The masks therefore have to be removed and attached in a new position again and again, which is connected to a very high fitting effort. The above-mentioned problems and disadvantages can now be avoided by the disclosure. In particular, the disclosure avoids excessive wrinkling in the uncoated strip, and excessive time-consuming and costly measures such as the above-mentioned masking can be avoided.

The conductor foil or the structural unit is guided, for example, from the deflection roller to a coiler, by way of which the conductor foil provided with the dried conducting tracks and comprising strips is in particular wound into a coil. It has been found that conventionally undesired wrinkling occurs precisely at the point located after the end of the dryer line and shortly before the first deflection roller. It is now provided according to the disclosure, preferably shortly before the deflection roller and therefore shortly before the first deflection of the conductor foil caused by the first deflection roller after the end of the dryer line, that the force be exerted on the strip by way of the roller such that the roller presses against the conductor foil and therefore the force acts from the first side toward the second side.

The roller is preferably a convex roller, which is very preferably formed round on the outer circumference, in particular circular. Since, for example, the conductor foil is supplied to the deflection roller such that the conductor foil is moved, in particular translationally, along the conveying direction toward the deflection roller, the conductor foil which is provided with the dried coating tracks is moved along the conveying direction relative to the roller or moved past the roller, in particular translationally, wherein during this the roller rolls, in particular directly, at least on the strip and touches the strip, in particular directly, in this case. Excessive wrinkling can advantageously be avoided in this way.

In order to reliably avoid excessive wrinkling and therefore to be able to produce the at least one electrode particularly advantageously, it is provided in one embodiment of the disclosure that the roller touches the entire strip along its entire width extending between the coating strips and in particular extending along the first straight line. The first straight line extends, for example, parallel to a first axis of rotation, around which the roller rotates in particular relative to a base element when the roller rolls in particular directly on the strip. For example, the first straight line extends parallel to a second axis of rotation around which the deflection roller rotates during the deflection of the conductor foil, in particular relative to a base element, so that preferably the first axis of rotation and the second axis of rotation extend parallel to one another and are spaced apart from one another. The mentioned force acts perpendicular to the first axis of rotation and also preferably perpendicular to the second axis of rotation here.

In a further, particularly advantageous embodiment of the disclosure, it is provided that a first point at which the roller exerts the force on the strip is spaced apart by at most 100 mm from a second point at which a tangent formed as a straight line that extends in a plane in which the lower side of the conductor foil facing away from the coating strip extends between the deflection roller and the end of the dryer line, is tangent to an outer-circumferential lateral surface of the deflection roller, which is preferably cylindrical on the outer circumference. Excessive wrinkling can be avoided particularly reliably in this way.

It has proven to be particularly advantageous here to avoid excessive wrinkling if the first point is spaced apart at most or precisely 50 mm from the second point.

A further embodiment is distinguished in that the roller protrudes beyond the strip toward the respective coating track, so that the roller also rolls, in particular directly, on a respective section of the respective coating track and thus also exerts the force on the respective section of the respective coating track.

It has proven to be particularly advantageous here if the respective section of the respective coating track is in particular at most or precisely 5 mm wide along the first straight line. Excessive wrinkling of the strip or the conductor foil as a whole can be avoided reliably in this way.

Finally, it has proven to be particularly advantageous if the roller penetrates at most or precisely 10 mm into the respective coating track, specifically viewed from the upper side toward the lower side, by which excessive wrinkling can be reliably avoided.

For example, in particular a width of the roller extending along the first straight line is, in particular precisely, 10 mm wider than the uncoated strip, in particular viewed along the first straight line. A protrusion of the roller by 5 mm in each case therefore results on the left and right adjacent to the uncoated strip, so that the roller also rolls on the respective coating track over a width of 5 mm. For example, in particular precisely, one roller, which exerts the mentioned force on the strip, is provided in each case per number of uncoated conductor strips between two coating tracks. For example, for the coating of the conductor foil using four coating tracks also referred to as useful strips, three rollers are therefore provided, since three uncoated strips are provided. The exertion of the force on the conductor foil or on the strip takes place, for example, via a setting of the penetration depth, which is 10 mm, for example. A position or positioning of the roller in the track transverse direction, i.e. along the first straight line, and the penetration depth, can be implemented, i.e. realized, for example, by way of a 2-axis system.

Further details of the invention result from the following description of a preferred exemplary embodiment with the associated drawings. In the figures:

### BRIEF DESCRIPTION OF THE DRAWINGS

FIG. 1 shows a detail of a schematic representation of a method for producing at least one electrode, in particular for a storage cell for storing, in particular electrochemically, electrical energy;

FIG. 2 shows a detail of a further schematic representation of the method; and

FIG. 3 shows a detail of a further schematic representation of the method.

In the figures, identical or functionally identical elements are provided with identical reference signs.

### DETAILED DESCRIPTION OF THE DRAWINGS

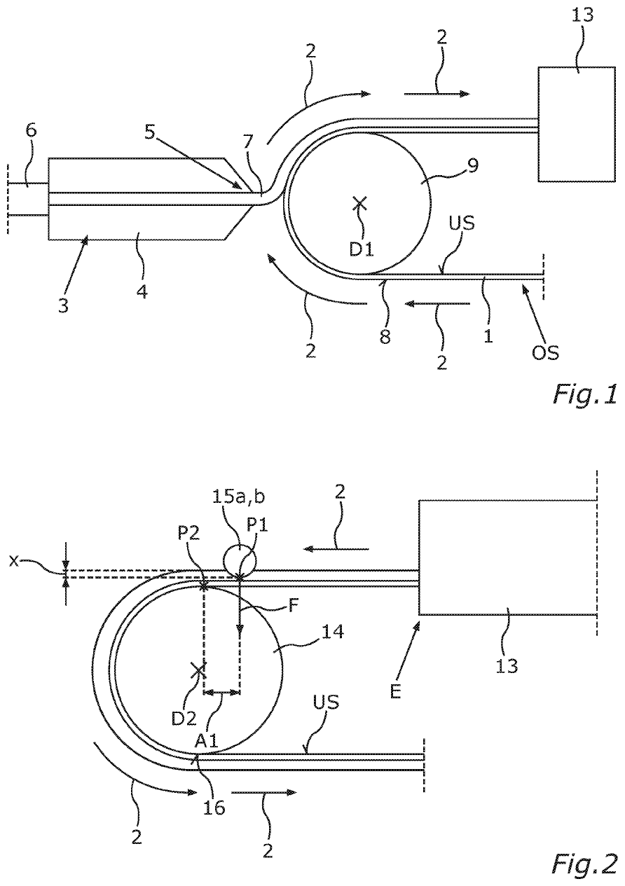

A method for producing at least one electrode, in particular for a storage cell for storing, in particular electrochemically, electrical energy is described hereinafter on the basis of FIGS. 1 to 3. This means that the at least one electrode can be used in particular after its production for the or in the mentioned storage cell, wherein electrical energy can be stored, in particular electrochemically, by way of the storage cell. For example, the storage cell is a lithium-ion cell. In the method, a metallic conductor foil 1, which is formed, for example, from copper and is also simply referred to as a foil, is conveyed along a conveying direction illustrated by arrows 2 and in this way in particular moved relative to an application unit 3, also referred to as an applicator unit. The application unit 3 comprises a slot die 4 having a slot die lip 5. By way of a material supply 6, which is shown particularly schematically in FIG. 1, an active material in particular in a liquid, in particular pasty state is supplied to the application unit 3, so that, for example, the active material is supplied as a paste to the application unit 3. The active material is designated by 7 in FIG. 1. The application unit 3 provides the active material 7 in particular in liquid, in particular pasty state of the active material 7, in particular in that the pasty or liquid active material 7 is sprayed out of the slot die 4, in particular out of the slot die lip. In this way, the active material 7 is applied, in particular directly, in the liquid or pasty state of the active material 7 to the conductor foil 1, i.e. in the present case to a first surface 8 of the conductor foil 1. The first surface 8 is a first side or is arranged on a first side of the conductor foil 1, wherein the first side is also referred to as the upper side OS of the conductor foil 1. As shown in FIG. 1 and as can be seen in particular on the basis of the arrows 2, the conductor foil 1 is supplied to a deflection roller, also referred to as an application roller 9, by way of which the conductor foil 1 is deflected, specifically in the present case by 180°. The active material 7 is applied to the surface 8 here by way of the application unit 3 while the conductor foil 1 is deflected by way of the application roller 9, by which the active material 7 is applied particularly advantageously to the surface 8, i.e. to the conductor foil 1.

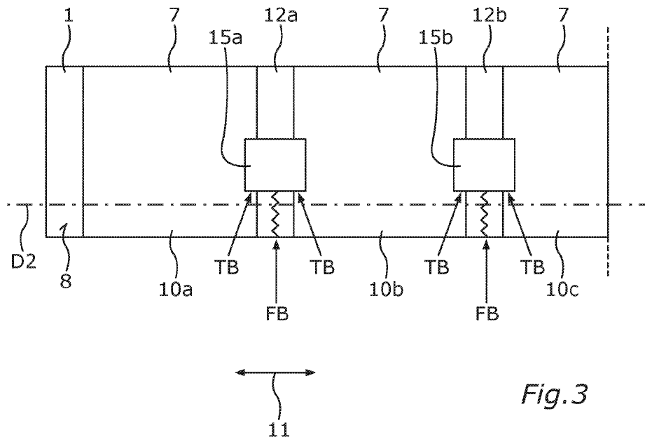

It can be seen from FIG. 3 that the active material 7 is applied by way of the application unit 3 to the surface 8 and therefore to the conductor foil 1 such that multiple coating tracks 10a-c made of the active material 7 are applied to the metallic conductor foil 1, in particular to the surface 8. The coating tracks 10a-c are applied adjacent to one another on the surface 8 such that the coating tracks 10a-c are spaced apart from one another in pairs along a first straight line illustrated by a double arrow, so that between each two adjacent coating tracks 10a-c, a respective strip 12a, b of the conductor foil 1, which is not coated using the active material 7 and is therefore uncoated, extends. It can be seen that the coating tracks 10a-c and the strips 12a, b are arranged or extend on the same side of the conductor foil 1, namely on its upper side OS. The application roller 9 is mounted rotatably on the first base element, for example, around a first axis of rotation D1 relative to a first base element (not shown in the figures) and rotates during the deflection of the conductor foil 1 moved by the application roller 9 around the axis of rotation D1 relative to the first base element, wherein the axis of rotation D1 extends parallel to the first straight line. It can be seen that the conductor foil 1 has a second side facing away from the upper side OS, which is referred to as the lower side US of the conductor foil 1. In this case, the application roller 9 rolls directly on the lower side US during the deflection of the conductor foil 1 caused by way of the application roller 9.

A detail of a dryer line 13, also simply referred to as a dryer, can be seen in each of FIGS. 1 and 2, wherein the conductor foil 1 provided with the coating tracks 10a-c is supplied to the dryer line 13 and conveyed through the dryer line 13, such that or in such a way that the conductor foil 1 is conveyed along the conveying direction to the dryer line 13 and is conveyed through the dryer line 13 and is therefore moved, in particular translationally, relative to the dryer line 13. The coating tracks 10 a-c, and therefore the active material 7, are dried by way of the dryer line 13. The conveying direction is also referred to as the track direction. One end of the dryer line 13 is designated by E in FIG. 2, which ends at its end E. It can be seen that the conductor foil 1 having the coating tracks 10a-c is conveyed, i.e. moved out of the dryer line 13 at the end E. The first deflection roller adjacent to the end E of the dryer line 13, by way of which the first deflection occurs after the end E of the dryer line 13, is designated by 14 in FIG. 2. The deflection roller 14 is mounted rotatably on the second base element, for example, around a second axis of rotation D2 relative to a second base element, wherein the deflection roller 14 rolls directly on the lower side US of the conductor foil 1 during the deflection of the conductor foil 1 caused by way of the deflection roller 14 and in this case rotates around the axis of rotation D2 relative to the second base element. The second axis of rotation D2 extends parallel to the first straight line and in the present case also parallel to the first axis of rotation D1 and is spaced apart from the first axis of rotation D1. It can be seen from FIG. 2 that the conductor foil 1 provided with the dried coating tracks 10a-c is deflected by 180° by way of the deflection roller.

In the method, the at least one electrode is produced from the conductor foil 1 provided with the dried coating tracks 10a-c in that, for example, the conductor foil 1 is in particular severed and in particular cut through here along the first straight line, so that, for example, multiple pieces of foil are produced from the conductor foil 1, which are each provided with respective parts of the coating tracks 10a-c.

A respective wrinkling of the respective uncoated strip 12a, b is designated by FB particularly schematically in FIG. 3. It can be seen that the respective wrinkling FB comprises in each case multiple wrinkles of the strip 12a, b.

In order to keep the wrinkling FB as minor as possible and therefore to be able to produce the at least one electrode particularly advantageously and in particular in a particularly time-favorable and cost-favorable manner, it is provided in the method that by way of a respective roller 15a, b after the end E of the dryer line 13 and before the deflection roller 14, i.e. before the deflection of the conductor foil 1 caused by way of the deflection roller 14, a respective force F (FIG. 2) is exerted at least on the respective strip 12a, b, in that the respective roller 15a, b at least directly touches the respective assigned strip 12a, b and rolls, in particular directly, on the respective strip 15a, b, while the conductor foil 1 provided with the dried coating tracks 10a-c is conveyed along the conveying direction. In the present case, the respective roller 15a, b touches the respective assigned strip 12a, b along its entire width extending along the first straight line and between the coating strips 10a, b or 10b, c, wherein in addition the respective roller 15a, b protrudes along the first straight line over the respective assigned strip 12a, b, so that the respective roller 15a, b also rolls on a respective section of the respective coating track 10a-c and thus also exerts the force F on the respective section of the respective coating track 10a-c. This respective section of the respective coating track 10a-c is designated by TB in FIG. 3.

A distance between a first point P1 and a second point P2 is designated by A1 in FIG. 2. In the first point P1, the respective roller 15a, b exerts the respective force F on the respective assigned strip 12a-b. In the second point P2, an imaginary tangent which extends in a plane in which the lower side US of the conductor foil 1 facing away from the coating strips 10a-c extends between the deflection roller 14 and the end E of the dryer line 13, is tangent on an outer-circumferential lateral surface 16 of the deflection roller 14, which is designed as cylindrical on the outer circumference in the present case. The outer-circumferential lateral surface 16 is therefore cylindrical. To keep the wrinkling FB as minor as possible, it is advantageously provided that the distance Al is at most or precisely 50 mm, wherein the distance extends along the conveying direction and therefore along a second straight line, which extends perpendicular to the first straight line.

In addition, a penetration depth is designated by x in FIG. 2. In this case, the respective roller 15a, b penetrates by the respective penetration depth x into the respective coating track 10a-c, wherein preferably the penetration depth x is at most, at least, or precisely 10 mm. The wrinkling FB can be kept as minor as possible in this way.

### LIST OF REFERENCE SIGNS

1 conductor foil
2 arrow
3 application unit
4 slot die
5 slot die lip
6 material supply
7 active material
8 first surface
9 application roller
10a-c coating track
11 double arrow
12a, b strip
13 dryer line
14 deflection roller
15a, b roller
16 outer-circumferential lateral surface
D1 first axis of rotation
US lower side
OS upper side
F force
A1 distance
D2 second axis of rotation
P1 first point
P2 second point
TB section
FB wrinkling

1.-7. (Canceled)

8. A method for producing at least one electrode, the method comprising:
applying at least two coating tracks comprising an active material adjacent to one another on a conductor foil, the coating tracks being spaced apart from one another such that a strip of the conductor foil not coated with the active material extends between the coating tracks;
supplying the conductor foil provided with the coating tracks to a dryer line and conveying the conductor foil through the dryer line, whereby the coating tracks are dried;
after drying, supplying the conductor foil provided with the coating tracks to a first deflection roller adjacent to an end of the dryer line whereby the conductor foil provided with the coating tracks is deflected; and
prior to deflection, exerting a force on the strip of the conductor foil with a pressure roller after the end of the dryer line and before the deflection roller,
wherein the pressure roller contacts and rolls on the strip, producing an electrode from the conductor foil provided with the coating tracks.

9. The method according to claim 8,
wherein
the pressure roller contacts the strip along its entire width extending between the coating strips.

10. The method according to claim 8,
wherein
a first point where the pressure roller exerts the force on the strip is spaced apart at most 100 mm from a second point on an outer-circumferential lateral surface of the deflection roller.

11. The method according to claim 10,
wherein a plane tangent to the second point extends between the deflection roller and the end of the dryer line along a lower side of the conductor foil facing away from the coating strips.

12. The method according to claim 10,
wherein
the first point is spaced apart at most 50 mm from the second point.

13. The method according to claim 8,
wherein
the pressure roller overlaps with respective sections of the coating tracks adjacent to the strip, thereby exerting the force on the respective sections.

14. The method according to claim 13,
wherein
the respective sections are each at most 5 mm wide.

15. The method according to claim 13,
wherein
the pressure roller penetrates at most 10 mm into the respective sections.
